(19) United States
(12) Patent Application Publication
(10) Pub. No.: US 2019/0160638 A1
(43) Pub. Date: May 30, 2019

(54) TOOL ASSEMBLY FOR SEALS AND METHODS OF USING THE SAME

(71) Applicant: SAINT-GOBAIN PERFORMANCE PLASTICS CORPORATION, Solon, OH (US)

(72) Inventors: Charles DELEUZE, Westborough, MA (US); James Fox, Salem, MA (US); Phil Bussone, Ipswich, MA (US); Marshall Dean, Wakefield, MA (US)

(21) Appl. No.: 16/202,316

(22) Filed: Nov. 28, 2018

Related U.S. Application Data
(60) Provisional application No. 62/592,461, filed on Nov. 30, 2017.

(51) Int. Cl. B25B 27/00; B23P 19/08

(52) U.S. Cl. CPC B25B 27/0028; B23P 19/084

(57) ABSTRACT

A tool assembly including at least one movable cam assembly including at least one cam, where the cam assembly is adapted to expand, contract, and eject a seal ring onto a component.

### CROSS-REFERENCE TO RELATED APPLICATION(S)

This application claims priority under 35 U.S.C. § 119(e) to U.S. Patent Application No. 62/592,461 entitled “TOOL ASSEMBLY FOR SEALS AND METHODS OF USING THE SAME,” by Charles DELEUZE et al., filed Nov. 30, 2017, which is assigned to the current assignee hereof and incorporated herein by reference in its entirety.

### FIELD OF THE DISCLOSURE

The present disclosure relates to tools for installing seal and seal assemblies, and more particularly to seals with multiple components.

### RELATED ART

Commonly, an assembly may include a component that may include a fluid component. A fluid component is used to inhibit or facilitate flow of a fluid. The fluid component can include for example, a pipe junction, a pipe coupling, a pipe, a pipe bend, a manifold, an elbow, a valve, a pump, a regulator, a seam or weld line, a nozzle or sprayer, a threaded port, a sampling valve, an exhaust line, a piston, a fluid inlet or outlet, or may be another component. In some cases, fluid components may use seals or seal assemblies to prevent leakage, contain pressure, contain a desired substance within the fluid component, or exclude contamination from the fluid component. In some particular cases, fluid components may need seals or seal assemblies that are used in difficult installation environments, such as in non-direct reachable grooves in piston seals. Further, some spring energized seals (i.e. seals including spring elements) may have difficulty expanding during installation in these difficult environments, producing difficult, cumbersome, and unreliable installation. In such cases, the seal or seal assembly may require reliable tools to make the installation process easier, however, some of these tools do not provide the efficiency and ease of use required. Therefore, there continues to be a need for tools to install seals and seal assemblies in difficult installation environments and harsh operating conditions.

### BRIEF DESCRIPTION OF THE DRAWINGS

Embodiments are illustrated by way of example and are not limited in the accompanying figures.

FIG. 1A includes a side view of a tool assembly in accordance with a number of embodiments.

FIG. 1B includes a front of a tool assembly in accordance with a number of embodiments.

FIG. 1C includes an overhead view of a tool assembly in accordance with a number of embodiments.

FIG. 1D includes a perspective side view of a tool assembly in accordance with a number of embodiments.

FIG. 2A includes a close up view of a gear assembly for a tool assembly in accordance with a number of embodiments.

FIG. 2B includes a close up view of a pusher arm assembly for a tool assembly in accordance with a number of embodiments.

FIG. 2C includes a close up view of an expansion ring for a tool assembly in accordance with a number of embodiments.

FIG. 2D includes a close up view of a cam assembly and a gear assembly for a tool assembly in accordance with a number of embodiments.

FIG. 3 includes a side cut-away view of an assembly including a seal and a fluid component in accordance with a number of embodiments.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive- or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the seal and/or seal assembly installation tool arts.

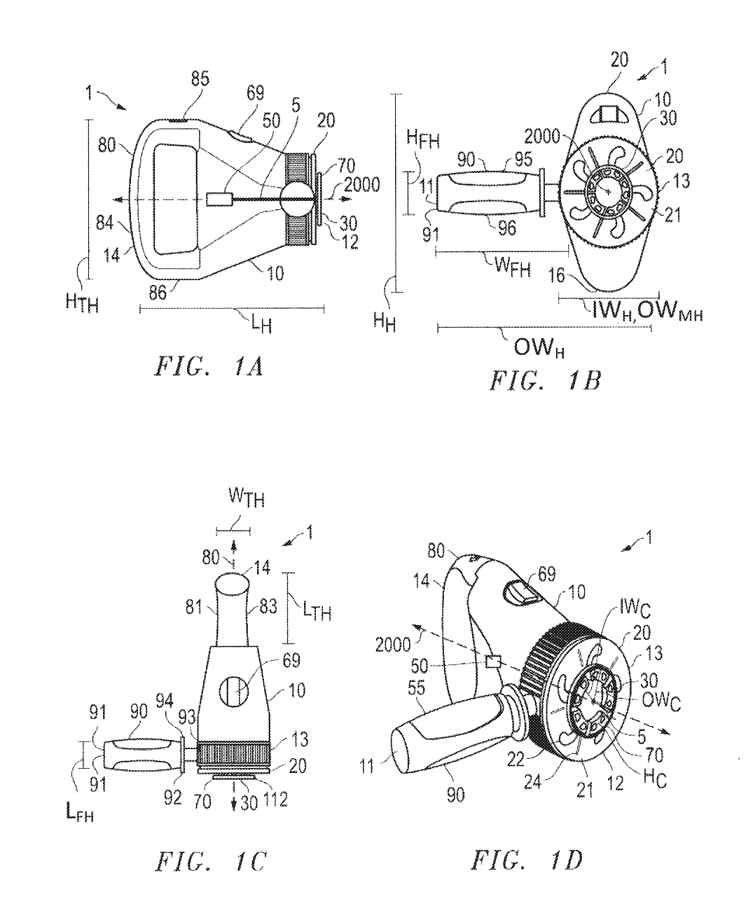

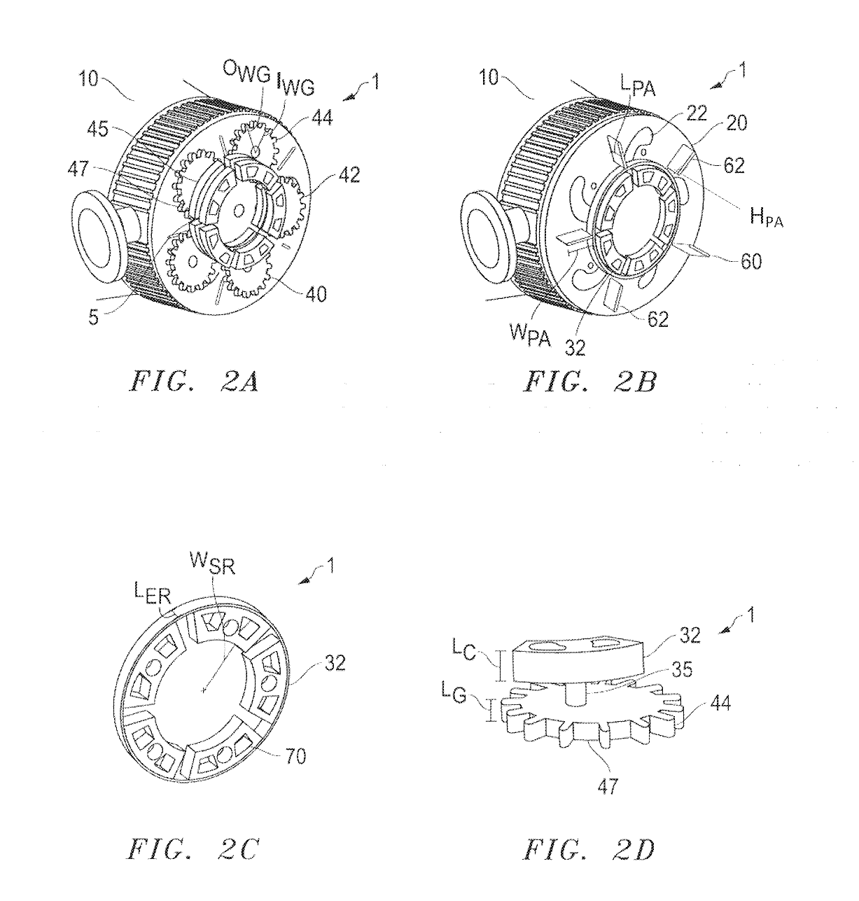

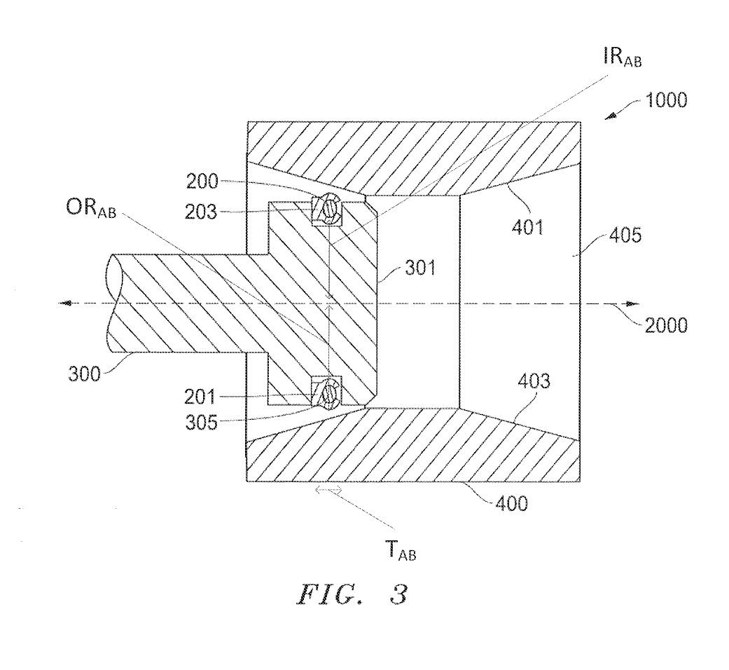

Referring initially to FIGS. 1A-2D, a tool assembly 1 is shown according to a number of embodiments. In a number of embodiments, the tool assembly 1 may be adapted to provide installation of a seal onto a component 300. In a number of embodiments, the tool assembly 1 may be adapted to provide installation of a seal onto a fluid component 300. In a number of embodiments, the tool assembly 1 may be adapted to provide installation of a seal or seal ring 200 onto a fluid component 300 in a non-limiting example of an assembly 1000 having a central axis 2000 as shown in FIG. 3. As shown in FIG. 3, the assembly 1000 may include a fluid component 300 (a piston as shown in the non-limiting example) having a first end 301 and a groove 305 disposed along the length of the fluid component 300. The assembly 1000 may further include a housing 400 having a first radial end 401 and a second radial end 403. The assembly 1000 may further include a seal 200 disposed in the grove 305 in the fluid component 300. The seal 200 may include a ring or first annular body 201. Optionally, the seal 200 may further include a second annular body 203. Optionally, the seal 200 may further include additional annular bodies. At least one of the first annular body 201 or the second annular body 203 may be formed in different cross-sectional shape geometries. Suitable geometries may include a square, U-shaped, C-shaped, rectangle, trapezoid, and other sealing element geometries that will be familiar to one of ordinary skill in the art. The seal 200 may be a spring energized seal with at least one of the first annular body 201 or the second annular body 203 forming a spring. As shown in FIG. 3, the second annular body 203 may be a spring at least partially surrounded by the first annular body 201 in the circumferential direction.

Referring back to FIGS. 1A-2D, in a number of embodiments, the tool assembly 1 can include a number of tool assembly components. In a number of embodiments, the tool assembly 1 may include a housing 10. In a number of embodiments, the tool assembly 1 can include a modular head 20. In a number of embodiments, the tool assembly 1 can include a cam assembly 30. In a number of embodiments, the tool assembly 1 can include a gearset assembly 40. In a number of embodiments, the tool assembly 1 can include a power component 50. In a number of embodiments, the tool assembly 1 can include a pusher arm assembly 60. In a number of embodiments, the tool assembly 1 can include an expansion ring 70. In a number of embodiments, the tool assembly 1 can include a twist handle 80. In a number of embodiments, the tool assembly 1 can include a fixed handle 90. In a number of embodiments, the tool assembly 1 (or any of the components listed above) may be adapted to expand, contract and/or eject a seal ring 200 onto a component 300. In a number of embodiments, the tool assembly 1 (or any of the components listed above) may be adapted to uniformly expand, contract and/or eject a seal ring 200 onto a fluid component 300.

In a number of embodiments, the tool assembly housing 10 may include a first axial end 12 and a second axial end 14 along an axis 2000. In a number of embodiments, the modular head 20 may be disposed on the first axial end 12 of the housing 10. The housing 10 may include a first radial end 11 and a second radial end 13. The housing 10 may include a third radial end 15 and a fourth radial end 16. The housing 10 of the tool assembly 1 may be used to house any of the other components of the tool assembly 1. Moreover, the housing 10 can comprise one or more fillets, rounded edges, angular components, or any combination thereof. The housing 10 may be any cross-sectional shape and may vary in dimensions along the axis 2000 in the axial or radial direction.

In a number of embodiments, the housing 10 may have a length L_{H} between the first axial end 12 and the second axial end 14. In a number of embodiments, the length L_{H} of the housing 10 may be at least 1 mm, 5 mm, at least 10 mm, at least 25 mm, at least 50 mm, at least 75 mm, at least 100 mm, at least 150 mm, at least 250 mm, at least 500 mm. The length L_{H} of the housing 10 may be no greater than 1000 mm, no greater than 750 mm, no greater than 500 mm, no greater than 200 mm, no greater than 150 mm, no greater than 100 mm. In a number of embodiments, the length L_{H} of the housing 10 may be at least 200 mm and no greater than 1000 mm.

In a number of embodiments, the housing 10 may have an inner width IW_{H}. In a number of embodiments, the inner width IW_{H} of the housing 10 may be at least 1 mm, 5 mm, at least 10 mm, at least 25 mm, at least 50 mm, at least 75 mm, at least 100 mm, at least 150 mm, at least 250 mm, at least 500 mm. The inner width IW_{H} of the housing 10 may be no greater than 500 mm, no greater than 400 mm, no greater than 300 mm, no greater than 200 mm, no greater than 150 mm, no greater than 100 mm. In a number of embodiments, the inner width IW_{H} of the housing 10 may be at least 200 mm and no greater than 600 mm.

In a number of embodiments, the housing 10 may have an outer width OW_{H} between the first radial end 11 and the second radial end 13. In a number of embodiments, the outer width OW_{H of} the housing 10 may be at least 1 mm, 5 mm, at least 10 mm, at least 25 mm, at least 50 mm, at least 75 mm, at least 100 mm, at least 150 mm, at least 250 mm, at least 500 mm, or at least 600 mm. The outer width OW_{H of} the housing 10 may be no greater than 600 mm, no greater than 400 mm, no greater than 300 mm, no greater than 200 mm, no greater than 150 mm, no greater than 100 mm. In a number of embodiments, the outer width OW_{H} of the housing 10 may be at least 200 mm and no greater than 600 mm.

In a number of embodiments, the housing 10 may have a height H_{H} between the third radial end 15 and the fourth radial end 16. In a number of embodiments, the height H_{H} of the housing 10 may be at least 1 mm, 5 mm, at least 10 mm, at least 25 mm, at least 50 mm, at least 75 mm, at least 100 mm, at least 150 mm, at least 250 mm, at least 500 mm. The height H_{H} of the housing 10 may be no greater than 500 mm, no greater than 400 mm, no greater than 300 mm, no greater than 200 mm, no greater than 150 mm, no greater than 100 mm. In a number of embodiments, the height _{HH} of the housing 10 may be at least 150 mm and no greater than 450 mm.

In a number of embodiments, the housing 10 can comprise any suitable material with sufficient rigidity to withstand axial and longitudinal forces. In a particular embodiment, the housing 10 can include a polymer or elastic material, such as, for example, ultra-high molecular weight polyurethane (UHMWPE), poly(vinyl chloride) (PVC), a polyketone, a polyaryletherketone (PEAK) such as polyether ether ketone (PEEK), a polyaramid, a polyimide, a polytherimide, a polyphenylene sulfide, a polyetherslfone, a polysulfone, a polypheylene sulfone, a polyamideimide, ultra high molecular weight polyethylene, a fluoropolymer, a polyamide, a polybenzimidazole, or any combination thereof. An example fluoropolymer includes fluorinated ethylene propylene (FEP), polytetrafluoroethylene (PTFE), polyvinylidene fluoride (PVDF), perfluoroalkoxy (PFA), a terpolymer of tetrafluoroethylene, hexafluoropropylene, and vinylidene fluoride (THV), polychlorotrifluoroethylene (PCTFE), ethylene tetrafluoroethylene copolymer (ETFE), ethylene chlorotrifluoroethylene copolymer (ECTFE), aliphatic polyamides, or even para-aramids such as Kevlar®, or any combination thereof. The polymer may be injection-molded. In another embodiment, the housing 10 can comprise a metal or alloy (such as, but not limited to, aluminum, chromium, nickel, zinc, copper, magnesium, tin, platinum, titanium, tungsten, lead, iron, bronze, steel, spring steel, stainless steel) formed through a machining process. In a number of embodiments, the metal may be lubricious. In yet another embodiment, the housing 10 can comprise a ceramic or any other suitable material. The housing 10 can comprise a homogenous composition or may comprise two or more discrete portions having different compositions. The housing 10 can be formed from a single piece, two pieces, or several pieces joined together by melting, sintering, welding, adhesive, fasteners, threading, or any other suitable fastening means. Moreover, in one non-limiting embodiment, although not applicable to all embodiments, the housing 10 may not include a polymer, and more particularly, may be essentially free of any/all polymers. In a particular aspect, the housing 10 may comprise a single material free of any coating or surface layer. In a number of embodiments, the housing 10 can comprise a coating on its surface. In a number of embodiments, the coating may include a lubricant. The lubricant may include a grease including at least one of lithium soap, lithium disulfide, graphite, mineral or vegetable oil, silicone grease, fluorether-based grease, apiezon, food-grade grease, petrochemical grease, or may be a different type. The lubricant may include an oil including at least one of a Group I-Group III+ oil, paraffinic oil, naphthenic oil, aromatic oil, biolubricant, castor oil, canola oil, palm oil, sunflower seed oil, rapeseed oil, tall oil, lanolin, synthetic oil, polyalpha-olefin, synthetic ester, polyalkylene glycol, phosphate ester, alkylated naphthalene, silicate ester, ionic fluid, multiply alkylated cyclopentane, petrochemical based, or may be a different type. In a certain aspect, the housing 10 can be formed from a monolithic construction. In another aspect, the housing 10 can be formed from multiple components joined together by any means recognizable in the art, such as, for example, by mechanical deformation (e.g., crimping or splines), adhesive, welding, melting, or any combination thereof.

Referring to FIGS. 1A-2D, in a number of embodiments, the modular head 20 may couple to the housing 10 at a first axial end 14 of the housing 10. In a number of embodiments, the modular head 21 may include a face 21. In a number of embodiments, the modular head 20 may have a circular, semicircular, or oval shape. In a number of embodiments, the modular head 20 may be any cross-sectional shape and may vary in dimensions along the axis 2000 in the axial or radial direction. In a number of embodiments, the modular head 20 may include an attachment component 25 to attach the modular head 20 to the housing 10. In a number of embodiments, the attachment component 25 may be a mechanical attachment (such as a screw in attachment with corresponding threadings), mechanical deformation (e.g., crimping or splines), adhesive, welding, melting, fastening, or any other way. In a number of embodiments, the modular head may have a length L_{MH} within the dimensions listed for the length L_{H} of the housing 10. In a number of embodiments, the modular head may have an inner width IW_{MH} within the dimensions listed for the inner width IW_{H} of the housing 10. In a number of embodiments, the modular head may have an outer width OW_{MH} within the dimensions listed for the outer width OW_{H} of the housing 10. In a number of embodiments, the modular head may have a height H_{MH} within the dimensions listed for the height H_{H} of the housing 10.

In a number of embodiments, the modular head 20 can comprise any suitable material with sufficient rigidity to withstand axial and longitudinal forces. In a particular embodiment, the modular head 20 can include a polymer or elastic material, such as, for example, ultra-high molecular weight polyurethane (UHMWPE), poly(vinyl chloride) (PVC), a polyketone, a polyaryletherketone (PEAK) such as polyether ether ketone (PEEK), a polyaramid, a polyimide, a polytherimide, a polyphenylene sulfide, a polyetherslfone, a polysulfone, a polypheylene sulfone, a polyamideimide, ultra high molecular weight polyethylene, a fluoropolymer, a polyamide, a polybenzimidazole, or any combination thereof. An example fluoropolymer includes fluorinated ethylene propylene (FEP), polytetrafluoroethylene (PTFE), polyvinylidene fluoride (PVDF), perfluoroalkoxy (PFA), a terpolymer of tetrafluoroethylene, hexafluoropropylene, and vinylidene fluoride (THV), polychlorotrifluoroethylene (PCTFE), ethylene tetrafluoroethylene copolymer (ETFE), ethylene chlorotrifluoroethylene copolymer (ECTFE), aliphatic polyamides, or even para-aramids such as Kevlar®, or any combination thereof. The polymer may be injection-molded. In another embodiment, the modular head 20 can comprise a metal or alloy (such as, but not limited to, aluminum, chromium, nickel, zinc, copper, magnesium, tin, platinum, titanium, tungsten, lead, iron, bronze, steel, spring steel, stainless steel) formed through a machining process. In a number of embodiments, the metal may be lubricious. In yet another embodiment, the modular head 20 can comprise a ceramic or any other suitable material. The modular head 20 can comprise a homogenous composition or may comprise two or more discrete portions having different compositions. The modular head 20 can be formed from a single piece, two pieces, or several pieces joined together by melting, sintering, welding, adhesive, fasteners, threading, or any other suitable fastening means. Moreover, in one non-limiting embodiment, although not applicable to all embodiments, the housing 10 may not include a polymer, and more particularly, may be essentially free of any/all polymers. In a particular aspect, the modular head 20 may comprise a single material free of any coating or surface layer. In a number of embodiments, the modular head 20 can comprise a coating on its surface. In a number of embodiments, the coating may include a lubricant. The lubricant may include a grease including at least one of lithium soap, lithium disulfide, graphite, mineral or vegetable oil, silicone grease, fluorether-based grease, apiezon, food-grade grease, petrochemical grease, or may be a different type. The lubricant may include an oil including at least one of a Group I-Group III+ oil, paraffinic oil, naphthenic oil, aromatic oil, biolubricant, castor oil, canola oil, palm oil, sunflower seed oil, rapeseed oil, tall oil, lanolin, synthetic oil, polyalpha-olefin, synthetic ester, polyalkylene glycol, phosphate ester, alkylated naphthalene, silicate ester, ionic fluid, multiply alkylated cyclopentane, petrochemical based, or may be a different type. In a certain aspect, the modular head 20 can be formed from a monolithic construction. In another aspect, the modular head 20 can be formed from multiple components joined together by any means recognizable in the art, such as, for example, by mechanical deformation (e.g., crimping or splines), adhesive, welding, melting, or any combination thereof.

In a number of embodiments, the modular head 20 may include at least one aperture 22. In a number of embodiments, the modular head 20 may include a plurality of cam apertures 22. In a number of embodiments, the cam apertures 22 may allow movement of the cam assembly 30 along the plane of the modular head 20. In a number of embodiments, the cam apertures 22 may allow movement of the cam assembly 30 along the plane of the modular head 20 in the radial direction. In a number of embodiments, the cam apertures may be polygonal, oval, circular, or semi-circular in shape. In a number of embodiments the cam apertures 22 may follow an arced or arcuate path along the face 21 of the modular head 20 in a direction from the central axis 2000 towards the outer width OW_{MH} of the modular head 20. In a number of embodiments, the cam apertures may be arced in the clockwise direction. In a number of embodiments, the cam apertures 22 may be arced in the counter-clockwise direction. In a number of embodiments, the modular head 20 may include a plurality of pusher arm apertures 24. In a number of embodiments, the pusher arm apertures 24 may allow movement of the pusher arm assembly 60 in and out of the plane of the modular head 20 in the axial direction (along the axis 20000). In a number of embodiments, the pusher arm apertures 24 may be polygonal, oval, circular, or semi-circular in shape. In a number of embodiments, as shown in FIG. 1D, the pusher arm apertures 24 may be linear in path in a direction from the central axis 2000 towards the outer width OW_{MH} of the modular head 20.

Referring to FIGS. 1A-2D, in a number of embodiments, the tool assembly housing 10 may include a twist handle 80. The twist handle 80 may include first end 82 and a second end 84 along an axis 2000. The twist handle 80 may include a first radial end 81 and a second radial end 83. The twist handle 80 may include a third radial end 85 and a sixth radial end 86. The twist handle 80 may be used by a user to hang onto the tool assembly 1 during installation of the seal 200 onto a fluid component 300. Moreover, the twist handle 80 can comprise one or more fillets, rounded edges, angular components, or any combination thereof. The twist handle 80 may be any cross-sectional shape and may vary in dimensions along the axis 2000 in the axial or radial direction. The twist handle 80 may be made of any of the materials listed above for the housing 10.

In a number of embodiments, the twist handle 80 may have a length L_{TH} between the first axial end 82 and the second axial end 84. In a number of embodiments, the length L_{TH} of the twist handle 80 may be at least 1 mm, 5 mm, at least 10 mm, at least 25 mm, at least 50 mm, at least 75 mm, at least 100 mm, at least 150 mm, at least 250 mm, at least 500 mm. The length L_{TH} of the twist handle 80 may be no greater than 500 mm, no greater than 400 mm, no greater than 300 mm, no greater than 200 mm, no greater than 150 mm, no greater than 100 mm. In a number of embodiments, the twist handle 80 may have a length L_{TH} that may be at least 150 mm and no greater than 450 mm.

In a number of embodiments, the twist handle 80 may have a width W_{TH} between the first radial end 81 and the second radial end 83. In a number of embodiments, the width W_{TH} of the twist handle 80 may be at least 1 mm, 5 mm, at least 10 mm, at least 25 mm, at least 50 mm. The width W_{TH} of the twist handle 80 may be no greater than 50 mm, no greater than 40 mm, no greater than 30 mm, no greater than 20 mm, no greater than 15 mm, no greater than 10 mm. In a number of embodiments, the twist handle 80 may have a width W_{TH} that may be at least 20 mm and no greater than 45 mm.

In a number of embodiments, the twist handle 80 may have a height H_{TH} between the third radial end 95 and the fourth radial end 96. In a number of embodiments, the height H_{TH} of the twist handle 80 may be at least 1 mm, 5 mm, at least 10 mm, at least 25 mm, at least 50 mm, at least 75 mm, at least 100 mm, at least 150 mm, at least 250 mm, at least 500 mm. The height H_{FH} of the twist handle 80 may be no greater than 500 mm, no greater than 400 mm, no greater than 300 mm, no greater than 200 mm, no greater than 150 mm, no greater than 100 mm. In a number of embodiments, the twist handle 80 may have a height H_{TH} that may be at least 150 mm and no greater than 450 mm.

Still referring to FIGS. 1A-2D, in a number of embodiments, the tool assembly housing 10 may include a fixed handle 90. The fixed handle 90 may include first end 92 and a second end 94 along an axis 2000. The fixed handle 90 may include a first radial end 91 and a second radial end 93. The fixed handle 90 may include a third radial end 95 and a sixth radial end 96. The fixed handle 90 may be used by a user to hang onto the tool assembly 1 during installation of the seal 200 onto a fluid component 300. Moreover, the fixed handle 90 can comprise one or more fillets, rounded edges, angular components, or any combination thereof. The fixed handle 90 may be any cross-sectional shape and may vary in dimensions along the axis 2000 in the axial or radial direction. The fixed handle 90 may be made of any of the materials listed above for the housing 10.

In a number of embodiments, the fixed handle 90 may have a length L_{FH} between the first axial end 92 and the second axial end 94. In a number of embodiments, the length L_{FH} of the fixed handle 90 may be at least 1 mm, 5 mm, at least 10 mm, at least 25 mm, at least 50 mm. The fixed handle 90 may have a length L_{FH} may be no greater than 50 mm, no greater than 40 mm, no greater than 30 mm, no greater than 20 mm, no greater than 15 mm, no greater than 10 mm. In a number of embodiments, fixed handle 90 may have a length L_{FH} that may be at least 20 mm and no greater than 45 mm.

In a number of embodiments, the fixed handle 90 may have a width W_{FH} between the first radial end 91 and the second radial end 93. In a number of embodiments, the width W_{FH} of the fixed handle 90 may be at least 1 mm, 5 mm, at least 10 mm, at least 25 mm, at least 50 mm, at least 75 mm, at least 100 mm, at least 150 mm, at least 250 mm, at least 500 mm. The width W_{FH of} the fixed handle 90 may be no greater than 500 mm, no greater than 400 mm, no greater than 300 mm, no greater than 200 mm, no greater than 150 mm, no greater than 100 mm. In a number of embodiments, fixed handle 90 may have a width W_{FH} that may be at least 200 mm and no greater than 600 mm.

In a number of embodiments, the fixed handle 90 may have a height H_{FH} between the third radial end 95 and the fourth radial end 96. In a number of embodiments, the height H_{FH} of the fixed handle 90 may be at least 1 mm, 5 mm, at least 10 mm, at least 25 mm, at least 50 mm. The fixed handle 90 may have a height H_{FH} may be no greater than 50 mm, no greater than 40 mm, no greater than 30 mm, no greater than 20 mm, no greater than 15 mm, no greater than 10 mm. In a number of embodiments, fixed handle 90 may have a height H_{FH} that may be at least 20 mm and no greater than 45 mm.

In a number of embodiments, the fixed handle 90 may form a void 97 in the housing 10. The void 97 may allow for a user to grip the housing 10 and the tool assembly 1. The void may be any shape and may vary in dimensions along the axis 2000.

Still referring to FIGS. 1A-2D, in a number of embodiments, the tool assembly 1 may include a power component 50. In a number of embodiments, the power component 50 may operate or power at least one of the cam assembly 30, the gearset assembly 40, or the pusher arm assembly 60. The power component 50 can include a number of components for mechanically driving a tool including, but not limited to, a drive motor, an electric motor, an engine, a battery, battery charger, converter, clutch, drivetrain, or may include another component known in the power tool and electric tool arts. In a number of embodiments, the power component 50 may include an actuation button 55 that a user may use to drive the power component 50 to power the tool assembly 10 and any of its components. The actuation button 50 may be located on the housing 10 to be accessible to the user. In a number of embodiments, the power component 50 may further include a plurality of electric connections or wires, wireless, WAN, LAN, Bluetooth, Wi-Fi, ANT (i.e. GARMIN low power usage protocol), or any suitable power or signal transmitting mechanism operatively connected to at least one of cam assembly 30, the gearset assembly 40, or the pusher arm assembly 60, or may include another component to use the power from the power component 50 to power the tool assembly 1. The power component 50 may be rechargeable. The power component 50 (or a portion of the power component 50) may be removable from the tool assembly 1 for recharging in a separate recharging base. In a number of embodiments, the power component 50 may include a user-powered mechanism. In a number of embodiments, the user-powered mechanism may include an internal gearset, pulley system, or other means that is rotated by the user to rotate a shaft 5 that operates the tool assembly 1 as discussed below. The user-power mechanism may include the fixed handle 90 or twist handle 80 to operate the shaft 5. In a number of embodiments, the user-powered mechanism may allow for rotation of the fixed handle 90 to power the rotation of the shaft 5 to operate the tool assembly 1. The power component 50 may fit within the housing 10 of the tool assembly 1. The power component 50 may have similar dimensions to the dimensions of the housing 10 listed above. The power component 50 may be made of any of the materials listed above for the housing 10 or any materials known for power generation in the arts.

Still referring to FIGS. 1A-2D, in a number of embodiments, the tool assembly 1 may include a transmission or gearset assembly 40. In a number of embodiments, the power component 50 may be operatively connected to the gearset assembly 40. In a number of embodiments, the power component 50 may actuate the gearset assembly 40 into motion. In a number of embodiments, the power component 50 may include at least one shaft 5 that is operatively connected to the gearset assembly 40 and/or the pusher arm assembly 60. In a number of embodiments, the power component 50 may include a plurality of shafts 5 that are operatively connected to the gearset assembly 40 and/or the pusher arm assembly 60. In a number of embodiments, the gearset assembly 40 may include a gear train 42. In a number of embodiments, the gear train 42 may include at least one gear 44. In a number of embodiments, the shaft 5 is operatively connected to turn at least one gear 44 in the gear train 42. In a number of embodiments, the shaft 5 of the power component may be operatively connected to turn at least one gear 44 in the gear train 42. In a number of embodiments, the gear 44 may include an external or an internal gear. In a number of embodiments, the gear 44 may include at least one of a spur gear, a helical gear, a skew gear, a double helical gear, a bevel gear, a spiral bevel gear, a crown gear, a hypoid gear, a worm gear, a non-circular gear, a rack and pinion gear, an epicyclic gear, a sun gear, a planet gear, a harmonic gear, a cage gear, a magnetic gear, or may be another type. In a number of embodiments, the gear train 42 may include a plurality of gears 44. In a number of embodiments, the gears 44 may rotate through actuation or rotation of the shaft 5 as powered by the power component 50. In a number of embodiments, the gear train 42 may include a sun gear 45 that is coupled to the shaft 5 and may in turn rotate a plurality of planetary gears 47. The gears 44 of the gear train 42 head may have a length L_{G} within the dimensions listed for the length L_{H} of the housing 10. In a number of embodiments, the gears 44 of the gear train 42 may have an inner width IW_{G} (to a bottom land of the gear 44) within the dimensions listed for the inner width IW_{H} of the housing 10. In a number of embodiments, the gears 44 of the gear train 42 may have an outer width OW_{G} (to a top land of the gear 44) within the dimensions listed for the outer width OW_{H} of the housing 10.

In a number of embodiments, at least one of the gears 44 of the gear train 42 of the gearset assembly 40 can comprise any suitable material with sufficient rigidity to withstand axial and longitudinal forces. In a particular embodiment, at least one of the gears 44 of the gear train 42 of the gearset assembly 40 can include a polymer, such as, for example, ultra-high molecular weight polyurethane (UHMWPE), poly(vinyl chloride) (PVC), a polyketone, a polyaryletherketone (PEAK) such as polyether ether ketone (PEEK), a polyaramid, a polyimide, a polytherimide, a polyphenylene sulfide, a polyetherslfone, a polysulfone, a polypheylene sulfone, a polyamideimide, ultra high molecular weight polyethylene, a fluoropolymer, a polyamide, a polybenzimidazole, or any combination thereof. An example fluoropolymer includes fluorinated ethylene propylene (FEP), polytetrafluoroethylene (PTFE), polyvinylidene fluoride (PVDF), perfluoroalkoxy (PFA), a terpolymer of tetrafluoroethylene, hexafluoropropylene, and vinylidene fluoride (THV), polychlorotrifluoroethylene (PCTFE), ethylene tetrafluoroethylene copolymer (ETFE), ethylene chlorotrifluoroethylene copolymer (ECTFE), aliphatic polyamides, or even para-aramids such as Kevlar®, or any combination thereof. The polymer may be injection-molded. In another embodiment, at least one of the gears 44 of the gear train 42 of the gearset assembly 40 can comprise a metal or alloy (such as, but not limited to, aluminum, chromium, nickel, zinc, copper, magnesium, tin, platinum, titanium, tungsten, lead, iron, bronze, steel, spring steel, stainless steel) formed through a machining process. In a number of embodiments, the metal may be lubricious. In yet another embodiment, at least one of the gears 44 of the gear train 42 of the gearset assembly 40 can comprise a ceramic or any other suitable material. At least one of the gears 44 of the gear train 42 of the gearset assembly 40 can comprise a homogenous composition or may comprise two or more discrete portions having different compositions. At least one of the gears 44 of the gear train 42 of the gearset assembly 40 can be formed from a single piece, two pieces, or several pieces joined together by melting, sintering, welding, adhesive, fasteners, threading, or any other suitable fastening means. Moreover, in one non-limiting embodiment, although not applicable to all embodiments, at least one of the gears 44 of the gear train 42 of the gearset assembly 40 may not include a polymer, and more particularly, may be essentially free of any/all polymers. In a particular aspect, at least one of gears 44 of the gear train 42 of the gearset assembly 40 may comprise a single material free of any coating or surface layer. In a number of embodiments, at least one of the gears 44 of the gear train 42 of the gearset assembly 40 can comprise a coating on the surface of the gear 44. In a number of embodiments, the coating may include a lubricant. The lubricant may include a grease including at least one of lithium soap, lithium disulfide, graphite, mineral or vegetable oil, silicone grease, fluorether-based grease, apiezon, food-grade grease, petrochemical grease, or may be a different type. The lubricant may include an oil including at least one of a Group I-Group III+ oil, paraffinic oil, naphthenic oil, aromatic oil, biolubricant, castor oil, canola oil, palm oil, sunflower seed oil, rapeseed oil, tall oil, lanolin, synthetic oil, polyalpha-olefin, synthetic ester, polyalkylene glycol, phosphate ester, alkylated naphthalene, silicate ester, ionic fluid, multiply alkylated cyclopentane, petrochemical based, or may be a different type. In a certain aspect, at least one of the gears 44 of the gear train 42 of the gearset assembly 40 can be formed from a monolithic construction. In another aspect, at least one of the gears 44 of the gear train 42 of the gearset assembly 40 can be formed from multiple components joined together by any means recognizable in the art, such as, for example, by mechanical deformation (e.g., crimping or splines), adhesive, welding, melting, or any combination thereof.

Still referring to FIGS. 1A-2D, in a number of embodiments, the tool assembly 1 may include a pusher arm assembly 60. In a number of embodiments, the pusher arm assembly 60 may include at least one pusher arm 62. In a number of embodiments, the power component 50 may be operatively connected to the pusher arm assembly 60. In a number of embodiments, the power component 50 may actuate the pusher arm assembly 60 into motion. In a number of embodiments, the power component 50 may include a shaft 5 that is operatively connected to the pusher arm assembly 60. In a number of embodiments, the shaft 5 may actuate the pusher arm assembly 60 into motion. In a number of embodiments, the rotation of the shaft 5 by the power component 50 may actuate at least one pusher arm 62 of the pusher arm assembly to penetrate the pusher arm apertures 24 and allow the pusher arms 62 in and out of the plane of the modular head 20 in the axial direction (along the axis 20000) through the pusher arm apertures 24 in the modular head 20. In a number of embodiments, at least one of the pusher arms 62 of the pusher arm assembly 60 head may have a length L_{PA} within the dimensions listed for the length L_{H} of the housing 10. In a number of embodiments, at least one of the pusher arms 62 of the pusher arm assembly 60 may have a width W_{PA} within the dimensions listed for the inner width IW_{H} of the housing 10. In a number of embodiments, at least one of the pusher arms 62 of the pusher arm assembly 60 may have a height H_{PA} within the dimensions listed for the height H of the housing 10. In a number of embodiments, the tool assembly 1 or pusher arm assembly 60 may include an eject button 69. The eject button 69 may be operatively connected to the pusher arm assembly 60. In a number of embodiments, the eject button 69 may actuate the pusher arms 62 of the pusher arm assembly 60 to penetrate the pusher arm apertures 24 and allow the pusher arms 62 out of the plane of the modular head 20 in the axial direction (along the axis 20000). In a number of embodiments, the eject button 69 may actuate the pusher arms 62 of the pusher arm assembly 60 to retract through the pusher arm apertures 24 and allow the pusher arms 62 into of the plane of the modular head 20 in the axial direction (along the axis 20000). The eject button 69 may be powered by the power component in actuating the pusher arms 62 of the pusher arm assembly 60 to penetrate or retract the pusher arm apertures 24 of the modular head 20. The eject button 69 may have similar or lesser dimensions to the dimensions of the housing 10 listed above.

In a number of embodiments, at least one of the pusher arms 62 of the pusher arm assembly 60 can comprise any suitable material with sufficient rigidity to withstand axial and longitudinal forces. In a particular embodiment, at least one of the pusher arms 62 of the pusher arm assembly 60 can include a polymer, such as, for example, ultra-high molecular weight polyurethane (UHMWPE), poly(vinyl chloride) (PVC), a polyketone, a polyaryletherketone (PEAK) such as polyether ether ketone (PEEK), a polyaramid, a polyimide, a polytherimide, a polyphenylene sulfide, a polyetherslfone, a polysulfone, a polypheylene sulfone, a polyamideimide, ultra high molecular weight polyethylene, a fluoropolymer, a polyamide, a polybenzimidazole, or any combination thereof. An example fluoropolymer includes fluorinated ethylene propylene (FEP), polytetrafluoroethylene (PTFE), polyvinylidene fluoride (PVDF), perfluoroalkoxy (PFA), a terpolymer of tetrafluoroethylene, hexafluoropropylene, and vinylidene fluoride (THV), polychlorotrifluoroethylene (PCTFE), ethylene tetrafluoroethylene copolymer (ETFE), ethylene chlorotrifluoroethylene copolymer (ECTFE), aliphatic polyamides, or even para-aramids such as Kevlar®, or any combination thereof. The polymer may be injection-molded. In another embodiment, at least one of the pusher arms 62 of the pusher arm assembly 60 can comprise a metal or alloy (such as, but not limited to, aluminum, chromium, nickel, zinc, copper, magnesium, tin, platinum, titanium, tungsten, lead, iron, bronze, steel, spring steel, stainless steel) formed through a machining process. In a number of embodiments, the metal may be lubricious. In yet another embodiment, at least one of the pusher arms 62 of the pusher arm assembly 60 can comprise a ceramic or any other suitable material. At least one of the pusher arms 62 of the pusher arm assembly 60 can comprise a homogenous composition or may comprise two or more discrete portions having different compositions. At least one of the pusher arms 62 of the pusher arm assembly 60 can be formed from a single piece, two pieces, or several pieces joined together by melting, sintering, welding, adhesive, fasteners, threading, or any other suitable fastening means. Moreover, in one non-limiting embodiment, although not applicable to all embodiments, at least one of the pusher arms 62 of the pusher arm assembly 60 may not include a polymer, and more particularly, may be essentially free of any/all polymers. In a particular aspect, at least one of the pusher arms 62 of the pusher arm assembly 60 may comprise a single material free of any coating or surface layer. In a number of embodiments, at least one of the pusher arms 62 of the pusher arm assembly 60 can comprise a coating on the surface of the pusher arm 62. In a number of embodiments, the coating may include a lubricant. The lubricant may include a grease including at least one of lithium soap, lithium disulfide, graphite, mineral or vegetable oil, silicone grease, fluorether-based grease, apiezon, food-grade grease, petrochemical grease, or may be a different type. The lubricant may include an oil including at least one of a Group I-Group III+ oil, paraffinic oil, naphthenic oil, aromatic oil, biolubricant, castor oil, canola oil, palm oil, sunflower seed oil, rapeseed oil, tall oil, lanolin, synthetic oil, polyalpha-olefin, synthetic ester, polyalkylene glycol, phosphate ester, alkylated naphthalene, silicate ester, ionic fluid, multiply alkylated cyclopentane, petrochemical based, or may be a different type. In a certain aspect, at least one of the pusher arms 62 of the pusher arm assembly 60 can be formed from a monolithic construction. In another aspect, at least one of the pusher arms 62 of the pusher arm assembly 60 can be formed from multiple components joined together by any means recognizable in the art, such as, for example, by mechanical deformation (e.g., crimping or splines), adhesive, welding, melting, or any combination thereof.

Still referring to FIGS. 1A-2D, in a number of embodiments, the tool assembly 1 may include a cam assembly 30. In a number of embodiments, the cam assembly 30 may include at least one cam 32. A cam may be defined herein as a projection on a rotating part in machinery, designed to make contact with another part while rotating and to impart reciprocal or variable motion to it. In a number of embodiments, the power component 50 may be operatively connected to the cam assembly 30. In a number of embodiments, the power component 50 may actuate the cam assembly 30 into motion. In a number of embodiments, the power component 50 may include a shaft 5 that is operatively connected to the cam assembly 30. In a number of embodiments, the rotation of the shaft 5 by the power component 50 may translate at least one cam 32 of the cam assembly 30 to move along the path of the cam apertures 22 in the plane of the modular head 20 in the radial direction (of the axis 20000) through the cam apertures 22 in the modular head 20. In a number of embodiments, the shaft 5 is operatively connected to rotate at least one cam 30 in the cam assembly 30 along the path of the cam apertures 22. In a number of embodiments, a cam 32 of the cam assembly 30 may be operatively connected to at least one gear 44 of the gear train 42 of the gearset assembly 40. In a number of embodiments, the gearset assembly 40 may actuate the cam assembly 30 into motion. In a number of embodiments, as shown in FIG. 2D, each cam 32 of the cam assembly 30 may be operatively connected to only gear 44 of the gear train 42 of the gearset assembly 40. In a number of embodiments, the cam 32 may be connected to the gear 44 by a cam rod 35. In a number of embodiments, the at least one cam 32 may be offset from the radial center 45 of the gear 44. This offset may allow the cam 42 to move along the path of the cam apertures 22 in the modular head 20. At least one of the cams 32 can comprise one or more fillets, rounded edges, angular components, or any combination thereof. In a number of embodiments, the cam 32 may have a polygonal, semi-circular, circular, or oval cross-sectional shape. In an embodiment, as shown in FIG. 2D, the cam 32 may have a rounded trapezoidal cross-sectional shape. In a number of embodiments, different cams 32 may have different cross-sectional shapes. In a number of embodiments, the cams 32 of the cam assembly 30 may have a length L_{c} within the dimensions listed for the length L_{H} of the housing 10. In a number of embodiments, the cams 32 of the cam assembly 30 may have an inner width IW_{C} within the dimensions listed for the inner width IW_{H} of the housing 10. In a number of embodiments, the cams 32 of the cam assembly 30 may have an outer width OW_{E} within the dimensions listed for the outer width OW_{H} of the housing 10. In a number of embodiments, the cams 32 of the cam assembly 30 may have a height H_{C} within the dimensions listed for the height H_{H} of the housing.

In a number of embodiments, at least one of the cams 32 of the cam assembly 30 can comprise any suitable material with sufficient rigidity to withstand axial and longitudinal forces. In a particular embodiment, at least one of the cams 32 of the cam assembly 30 can include a polymer, such as, for example, ultra-high molecular weight polyurethane (UHMWPE), poly(vinyl chloride) (PVC), a polyketone, a polyaryletherketone (PEAK) such as polyether ether ketone (PEEK), a polyaramid, a polyimide, a polytherimide, a polyphenylene sulfide, a polyetherslfone, a polysulfone, a polypheylene sulfone, a polyamideimide, ultra high molecular weight polyethylene, a fluoropolymer, a polyamide, a polybenzimidazole, or any combination thereof. An example fluoropolymer includes fluorinated ethylene propylene (FEP), polytetrafluoroethylene (PTFE), polyvinylidene fluoride (PVDF), perfluoroalkoxy (PFA), a terpolymer of tetrafluoroethylene, hexafluoropropylene, and vinylidene fluoride (THV), polychlorotrifluoroethylene (PCTFE), ethylene tetrafluoroethylene copolymer (ETFE), ethylene chlorotrifluoroethylene copolymer (ECTFE), aliphatic polyamides, or even para-aramids such as Kevlar®, or any combination thereof. The polymer may be injection-molded. In another embodiment, at least one of the cams 32 of the cam assembly 30 can comprise a metal or alloy (such as, but not limited to, aluminum, chromium, nickel, zinc, copper, magnesium, tin, platinum, titanium, tungsten, lead, iron, bronze, steel, spring steel, stainless steel) formed through a machining process. In a number of embodiments, the metal may be lubricious. In yet another embodiment, at least one of the cams 32 of the cam assembly 30 can comprise a ceramic or any other suitable material. At least one of the cams 32 of the cam assembly 30 can comprise a homogenous composition or may comprise two or more discrete portions having different compositions. At least one of the cams 32 of the cam assembly 30 can be formed from a single piece, two pieces, or several pieces joined together by melting, sintering, welding, adhesive, fasteners, threading, or any other suitable fastening means. Moreover, in one non-limiting embodiment, although not applicable to all embodiments, at least one of the cams 32 of the cam assembly 30 may not include a polymer, and more particularly, may be essentially free of any/all polymers. In a particular aspect, at least one of the cams 32 of the cam assembly 30 may comprise a single material free of any coating or surface layer. In a number of embodiments, at least one of the cams 32 of the cam assembly 30 can comprise a coating on the surface of the cam 32. In a number of embodiments, the coating may include a lubricant. The lubricant may include a grease including at least one of lithium soap, lithium disulfide, graphite, mineral or vegetable oil, silicone grease, fluorether-based grease, apiezon, food-grade grease, petrochemical grease, or may be a different type. The lubricant may include an oil including at least one of a Group I-Group III+ oil, paraffinic oil, naphthenic oil, aromatic oil, biolubricant, castor oil, canola oil, palm oil, sunflower seed oil, rapeseed oil, tall oil, lanolin, synthetic oil, polyalpha-olefin, synthetic ester, polyalkylene glycol, phosphate ester, alkylated naphthalene, silicate ester, ionic fluid, multiply alkylated cyclopentane, petrochemical based, or may be a different type. In a certain aspect, at least one of the cams 32 of the cam assembly 30 can be formed from a monolithic construction. In another aspect, at least one of the cams 32 of the cam assembly 30 can be formed from multiple components joined together by any means recognizable in the art, such as, for example, by mechanical deformation (e.g., crimping or splines), adhesive, welding, melting, or any combination thereof.

Still referring to FIGS. 1A-2D, in a number of embodiments, the tool assembly 1 or cam assembly 30 may include an expansion ring 70. In a number of embodiments, the expansion ring 70 may surround at least one cam 32 of the cam assembly 30. In a number of embodiments, the expansion ring 70 may surround all the cams 32 in the cam assembly, as shown in FIGS. 1B, 1D, and 2A. In a number of embodiments, the expansion ring may be adapted to expand or contract based on movement of the cams 32 within the cam assembly 30 when moved by translation or rotation by the gear train 32 and the power component 50. The expansion ring 70 can comprise one or more fillets, rounded edges, angular components, or any combination thereof. In a number of embodiments, the expansion ring 70 may have a polygonal, semi-circular, circular, or oval cross-sectional shape. In an embodiment, as shown in FIG. 2C, the expansion ring 70 may have a circular shape. In a number of embodiments, the expansion ring 70 may contact at least one cam 32 of the cam assembly 30. In a number of embodiments, as shown in FIG. 2C, the expansion ring 70 may be disposed around all of the cams 32 of the cam assembly 30 to form its shape. In a number of embodiments, the expansion ring 70 may have a length L_{ER} within the dimensions listed for the length L_{H} of the housing 10. In a number of embodiments, the expansion ring 70 may have a width W_{ER} within the dimensions listed for the outer width OW_{H} of the housing 10. In a number of embodiments, the expansion ring 70 may contact the seal 200 around at least 120°, 150°, 180°, 210°, 240°, 270°, 300°, 330°, or 360° of the circumference of the expansion ring. In a number of embodiments, the expansion and/or contraction of the expansion ring 70 may be actuated through movement of the at least one cam 32 in the cam assembly 30, which may be actuated through actuation of the gearset assembly 40. In a number of embodiments, the expansion and/or contraction of the expansion ring 70 may in turn expand and/or contract the seal 200 when placed into contact with it through actuation of the cam assembly 30. In a number of alternative embodiments, the cam assembly 30 may directly expand and/or contract the seal 200 when placed into contact with it through actuation of the gearset assembly 40. In other words, an expansion ring 70 may be included optionally to provide more points of contact between the tool assembly 1 and the seal 200.

In a number of embodiments, the expansion ring 70 can comprise any suitable material with sufficient rigidity to withstand axial and longitudinal forces. In a particular embodiment, the expansion ring 70 can include a polymer or elastic material, such as, for example, ultra-high molecular weight polyurethane (UHMWPE), poly(vinyl chloride) (PVC), a polyketone, a polyaryletherketone (PEAK) such as polyether ether ketone (PEEK), a polyaramid, a polyimide, a polytherimide, a polyphenylene sulfide, a polyetherslfone, a polysulfone, a polypheylene sulfone, a polyamideimide, ultra high molecular weight polyethylene, a fluoropolymer, a polyamide, a polybenzimidazole, or any combination thereof. An example fluoropolymer includes fluorinated ethylene propylene (FEP), polytetrafluoroethylene (PTFE), polyvinylidene fluoride (PVDF), perfluoroalkoxy (PFA), a terpolymer of tetrafluoroethylene, hexafluoropropylene, and vinylidene fluoride (THV), polychlorotrifluoroethylene (PCTFE), ethylene tetrafluoroethylene copolymer (ETFE), ethylene chlorotrifluoroethylene copolymer (ECTFE), aliphatic polyamides, or even para-aramids such as Kevlar®, or any combination thereof. The polymer may be injection-molded. In another embodiment, the expansion ring 70 can comprise a metal or alloy (such as, but not limited to, aluminum, chromium, nickel, zinc, copper, magnesium, tin, platinum, titanium, tungsten, lead, iron, bronze, steel, spring steel, stainless steel) formed through a machining process. In a number of embodiments, the metal may be lubricious. In yet another embodiment, the expansion ring 70 can comprise a ceramic or any other suitable material. The expansion ring 70 can comprise a homogenous composition or may comprise two or more discrete portions having different compositions. The expansion ring 70 can be formed from a single piece, two pieces, or several pieces joined together by melting, sintering, welding, adhesive, fasteners, threading, or any other suitable fastening means. Moreover, in one non-limiting embodiment, although not applicable to all embodiments, the expansion ring 70 may not include a polymer, and more particularly, may be essentially free of any/all polymers. In a particular aspect, the expansion ring 70 may comprise a single material free of any coating or surface layer. In a number of embodiments, the expansion ring 70 can comprise a coating on the surface of at least one cam 32. In a number of embodiments, the coating may include a lubricant. The lubricant may include a grease including at least one of lithium soap, lithium disulfide, graphite, mineral or vegetable oil, silicone grease, fluorether-based grease, apiezon, food-grade grease, petrochemical grease, or may be a different type. The lubricant may include an oil including at least one of a Group I-Group III+ oil, paraffinic oil, naphthenic oil, aromatic oil, biolubricant, castor oil, canola oil, palm oil, sunflower seed oil, rapeseed oil, tall oil, lanolin, synthetic oil, polyalpha-olefin, synthetic ester, polyalkylene glycol, phosphate ester, alkylated naphthalene, silicate ester, ionic fluid, multiply alkylated cyclopentane, petrochemical based, or may be a different type. In a certain aspect, the expansion ring 70 can be formed from a monolithic construction. In another aspect, the expansion ring 70 can be formed from multiple components joined together by any means recognizable in the art, such as, for example, by mechanical deformation (e.g., crimping or splines), adhesive, welding, melting, or any combination thereof.

In a number of embodiments, the at least one annular body 201, 203 of the seal 200 shown in FIG. 3 can include an inner radius IR_{AB} and an outer radius OR_{AB} about the central axis 2000. The at least one annular body 201, 203 also may include a nominal axial thickness T_{AB}. In a number of embodiments, the at least one annular body 201, 203 can be generally cylindrical and can further include an aperture 600. In a particular aspect, the aperture 600 can be coaxial, or substantially coaxial, with the central axis 2000.

In a number of embodiments, the inner radius IR_{AB} of at least one annular body 201, 203 of the seal 200 may be at least 1 mm, 5 mm, at least 10 mm, at least 25 mm, at least 50 mm, at least 75 mm, at least 100 mm, at least 150 mm, at least 250 mm, at least 500 mm. The inner radius IR_{AB} of the first annular body 2 of the seal 200 may be no greater than 5000 mm, no greater than 4000 mm, no greater than 3000 mm, no greater than 2000 mm, no greater than 1500 mm, no greater than 1000 mm. In a number of embodiments, the inner radius IR_{AB} of at least one annular body 201, 203 of the seal 200 may be at least 3 mm and no greater than 3 m.

In a number of embodiments, the outer radius OR_{AB} of at least one annular body 201, 203 of the seal 200 may be at least 1 mm, 5 mm, at least 10 mm, at least 25 mm, at least 50 mm, at least 75 mm, at least 100 mm, at least 150 mm, at least 250 mm, at least 500 mm. The outer radius OR_{AB} of the first annular body 2 of the seal 200 may be no greater than 5000 mm, no greater than 4000 mm, no greater than 3000 mm, no greater than 2000 mm, no greater than 1500 mm, no greater than 1000 mm. In a number of embodiments, the inner radius OR_{AB} of at least one annular body 201, 203 of the seal 200 may be at least 3 mm and no greater than 3 m.

In a number of embodiments, the nominal axial thickness T_{AB} of at least one annular body 201, 203 of the seal 200 may be at least , 0.25 mm, 0.5 mm, 1 mm, 5 mm, at least 10 mm, at least 25 mm, at least 50 mm, at least 75 mm, at least 100 mm. The nominal axial thickness T_{AB} of the first annular body 2 of the seal 200 may be no greater than 50 mm, no greater than 40 mm, no greater than 30 mm, no greater than 20 mm, no greater than 15 mm, no greater than 10 mm. In a number of embodiments, the nominal axial thickness T_{AB} of at least one annular body 201, 203 of the seal 200 may be at least 0.5 mm and no greater than 25 mm.

In a particular aspect, at least one annular body 201, 203 of the seal 200 can include a polymer or elastic material, such as, for example, ultra-high molecular weight polyurethane (UHMWPE), poly(vinyl chloride) (PVC), a polyketone, a polyaryletherketone (PEAK) such as polyether ether ketone (PEEK), a polyaramid, a polyimide, a polytherimide, a polyphenylene sulfide, a polyetherslfone, a polysulfone, a polypheylene sulfone, a polyamideimide, ultra high molecular weight polyethylene, a fluoropolymer, a polyamide, a polybenzimidazole, or any combination thereof. An example fluoropolymer includes fluorinated ethylene propylene (FEP), polytetrafluoroethylene (PTFE), polyvinylidene fluoride (PVDF), perfluoroalkoxy (PFA), a terpolymer of tetrafluoroethylene, hexafluoropropylene, and vinylidene fluoride (THV), polychlorotrifluoroethylene (PCTFE), ethylene tetrafluoroethylene copolymer (ETFE), ethylene chlorotrifluoroethylene copolymer (ECTFE), aliphatic polyamides, or even para-aramids such as Kevlar®, or any combination thereof. The polymer may be injection-molded. In another embodiment, at least one annular body 201, 203 of the seal 200 can comprise a metal or alloy (such as, but not limited to, aluminum, chromium, nickel, zinc, copper, magnesium, tin, platinum, titanium, tungsten, lead, iron, bronze, steel, spring steel, stainless steel) formed through a machining process. In a number of embodiments, the metal may be lubricious. In yet another embodiment, at least one annular body 201, 203 of the seal 200 can comprise a ceramic or any other suitable material. At least one annular body 201, 203 of the seal 200 can comprise a homogenous composition or may comprise two or more discrete portions having different compositions. The at least one annular body 201, 203 of the seal 200 can be formed from a single piece, two pieces, or several pieces joined together by melting, sintering, welding, adhesive, fasteners, threading, or any other suitable fastening means. Moreover, in one non-limiting embodiment, although not applicable to all embodiments, the at least one annular body 201, 203 of the seal 200 may not include a polymer, and more particularly, may be essentially free of any/all polymers. In a particular aspect, the at least one annular body 201, 203 of the seal 200 may comprise a single material free of any coating or surface layer. In a number of embodiments, the at least one annular body 201, 203 of the seal 200 can include a coating. In a number of embodiments, the coating may include a lubricant. The lubricant may include a grease including at least one of lithium soap, lithium disulfide, graphite, mineral or vegetable oil, silicone grease, fluorether-based grease, apiezon, food-grade grease, petrochemical grease, or may be a different type. The lubricant may include an oil including at least one of a Group I-Group III+ oil, paraffinic oil, naphthenic oil, aromatic oil, biolubricant, castor oil, canola oil, palm oil, sunflower seed oil, rapeseed oil, tall oil, lanolin, synthetic oil, polyalpha-olefin, synthetic ester, polyalkylene glycol, phosphate ester, alkylated naphthalene, silicate ester, ionic fluid, multiply alkylated cyclopentane, petrochemical based, or may be a different type. In a certain aspect, the at least one annular body 201, 203 of the seal 200 can be formed from a monolithic construction. In another aspect, the at least one annular body 201, 203 of the seal 200 can be formed from multiple components joined together by any means recognizable in the art, such as, for example, by mechanical deformation (e.g., crimping or splines), adhesive, welding, melting, or any combination thereof.

In a number of embodiments, at least one annular body 201, 203 of the seal 200 can be untreated or treated to enhance the physical or chemical properties thereof. For example, in particular embodiments, the seal 200 can be treated using techniques such as laser melting or ablation, mechanical sandblasting or chemical picking. In further embodiments, at least one annular body 201, 203 of the seal 200 can be treated by galvanizing, chromate or phosphate treatments, or anodizing. In a number of embodiments, the at least one annular body 201, 203 of the seal 200 may include a surface finish that cannot be achieved by machining. In a number of embodiments, the surface 35 of the seal 200 may be polished. In a number of embodiments, the seal 200 may have a surface finish provided by electrolytic polishing.

According to still another aspect, there may be provided a method including providing a seal 200, a fluid component 300, and tool assembly 1 including a housing 10, a gearset assembly 40, and at least one movable cam assembly 30 operatively connected to the gearset assembly 40, where the cam assembly 30 may be adapted to expand, contract, and eject a seal 200 onto the fluid component 300. The method may further include positioning the seal 200 onto the cam assembly 30 of the tool assembly 1. The method may further include expanding the seal 200 to a desired size by actuating the cam assembly 30 of the tool assembly 10. The method may further include ejecting the seal 200 from the cam assembly 30 of the tool assembly 10 onto the fluid component 10.

In more detail, in a number of embodiments, the method may include a first step of placing the seal 200 onto the expansion ring 70 of the tool assembly 10. In a number of embodiments, the user may then press an actuation button 55 that actuates the power component 50 to rotate the at least one shaft 5 to rotate at least one gear (sun gear 45) in the gearset assembly 40 to rotate at least one planetary gear 47 in the gearset assembly 40, which may in turn translate and/or rotate at least one cam 32 of the cam assembly 30 to move along the path of cam apertures 22 in the modular head 20 through connection with the cam rod 35. This movement of the cams 32 of the cam assembly 30 may expand the expansion ring 70 and the seal 200 placed on the expansion ring 70 along with it. Next, the method may include positioning the modular head 20 of the tool assembly 10 over a fluid component 300 such that the seal 200 aligns with a groove 305 in the fluid component 300. Next, the method may further include a user pressing the eject button 69 to actuate the power component 50 to force the pusher arms 62 pusher arm assembly 60 through the pusher arm apertures 24 in the modular head 20 to eject the seal 200 from the expansion ring 70 and into the groove 305 of the fluid component. Next, the method may further include the power component 50 contracting the cam assembly 30 to its original position by rotation of the shaft 5 in the opposite direction from above and/or returning the pusher arms 62 of the pusher arm assembly 60 back to their original position. The tool assembly 10 is then ready for reuse.

The tool assembly 10 or method described above may provide higher reliability and quality of sealing in difficult installation spaces and under more severe operating conditions (such as 20 ksi pressure, 200° C. temperature). They may provide ease of installation as a simple, versatile, and more robust solution compared to standard installation tools or regular spring-energized seals in difficult installation spaces. The installation may reduce the number of installation steps using the seal 200 from 8 steps down to 3 steps where additional tools may not be needed. Ease of installation may be facilitated across all seal diameters. Further, use of the tool assembly 10 via the cam assembly 30 may allow the seal 200 to be stretched uniformly along its circumference, providing for better and more efficient installation and better seal performance afterward on the fluid component 300.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the embodiments as listed below.

Embodiment 1: A tool assembly comprising: at least one movable cam assembly comprising at least one cam, wherein the cam assembly is adapted to expand, contract, and eject a seal ring onto a component.

Embodiment 2: A tool assembly comprising: a housing; a gearset assembly; and at least one movable cam assembly comprising at least one cam operatively connected to the gearset assembly, wherein the cam assembly is adapted to expand, contract, and eject a seal ring onto a component through actuation of the gearset assembly.

Embodiment 3: A method comprising: providing a seal, a fluid component, and tool assembly comprising: a housing, a gearset assembly, and at least one movable cam assembly operatively connected to the gearset assembly, where the cam assembly is adapted to expand, contract, and eject a seal ring onto a component; positioning the seal onto the cam assembly of the tool assembly; expanding the seal to a desired size by actuating the cam assembly of the tool assembly; and ejecting the seal from the cam assembly of the tool assembly onto the fluid component.

Embodiment 4: The tool assembly or method of any of the preceding embodiments, wherein the tool assembly comprises an expansion ring.

Embodiment 5: The tool assembly or method of any of the preceding embodiments, wherein at least one cam has a polygonal cross-sectional shape.

Embodiment 6: The tool assembly or method of any of the preceding embodiments, wherein the cam rotates and translates as the cam assembly is actuated.

Embodiment 7: The tool assembly or method of any of the preceding embodiments, wherein the cam radially translates as the cam assembly is actuated.

Embodiment 8: The tool assembly or method of any of the preceding embodiments, wherein the gearset assembly comprises a plurality of gears.

Embodiment 9: The tool assembly or method of embodiment 8, wherein at least one cam is operatively connected to at least one gear.

Embodiment 10: The tool assembly or method of any of the preceding embodiments, wherein the cam assembly further comprises a cam rod.

Embodiment 11: The tool assembly or method of any of the preceding embodiments, wherein the tool assembly further comprises a power component adapted to power at least one of the gearset assembly or the cam assembly.

Embodiment 12: The tool assembly or method of any of the preceding embodiments, wherein the tool assembly further comprises at least one pusher arm assembly.

Embodiment 13: The tool assembly or method of any of the preceding embodiments, wherein the housing further comprises a modular head for housing the movable cam assembly.

Embodiment 14: The tool assembly or method of any of the preceding embodiments, wherein the tool assembly further comprises a fixed handle.

Embodiment 15: The tool assembly or method of any of the preceding embodiments, wherein the tool assembly further comprises a twist handle.

Embodiment 16: The tool assembly or method of any of the preceding embodiments, wherein the tool assembly further comprises an eject button.

Embodiment 17: The tool assembly or method of any of the preceding embodiments, wherein the expansion ring comprises an elastomeric material.

Embodiment 18: The tool assembly or method of embodiments 2 or 3, wherein the tool assembly is adapted to expand a seal ring diameter from 3 mm to 3 mm.

Embodiment 19: The tool assembly or method of any of the preceding embodiments, wherein the cam assembly is made of a rigid material.

Embodiment 20: The tool assembly or method of any of the preceding embodiments, wherein the gearset assembly is made of a rigid material.

Embodiment 21: The tool assembly or method of any of the preceding embodiments, wherein the housing is made of a rigid material.

Embodiment 22: The tool assembly or method of embodiment 4, wherein the expansion ring contacts the seal around at least 120°, 150°, 180°, 210°, 240°, 270°, 300°, 330°, or 360° of the circumference of the expansion ring

This written description uses examples, including the best mode, and also to enable those of ordinary skill in the art to make and use the invention. The patentable scope of the invention is defined by the contacts, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. For example, embodiments may relate to rotational devices such as an electric motor, such as a windshield wiper motor), or axial sliding applications, such as a steering column adjustment mechanism.

While embodiments have been shown or described in only some of forms, it should be apparent to those skilled in the art that they are not so limited, but are susceptible to various changes without departing from the scope of the invention.

Note that not all of the features described above are required, that a portion of a specific feature may not be required, and that one or more features may be provided in addition to those described. Still further, the order in which features are described is not necessarily the order in which the features are installed.

Certain features are, for clarity, described herein in the context of separate embodiments, may also be provided in combination in a single embodiment. Conversely, various features that are, for brevity, described in the context of a single embodiment, may also be provided separately or in any subcombinations.

Benefits, other advantages, and solutions to problems have been described above with regard to specific embodiments, However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or any change may be made without departing from the scope of the disclosure. Accordingly, the disclosure is to be regarded as illustrative rather than restrictive.

What is claimed is:

1. A tool assembly comprising:
at least one movable cam assembly comprising at least one cam, wherein the cam assembly is adapted to expand, contract, and eject a seal ring onto a component.

2. The tool assembly of claim 1, wherein the tool assembly comprises an expansion ring.

3. The tool assembly of claim 1, wherein at least one cam has a polygonal cross-sectional shape.

4. The tool assembly of claim 1, wherein the cam rotates and translates as the cam assembly is actuated.

5. The tool assembly of claim 1, wherein the cam radially translates as the cam assembly is actuated.

6. The tool assembly of claim 1, wherein at least one cam is operatively connected to at least one gear.

7. The tool assembly of claim 1, wherein the cam assembly further comprises a cam rod.

8. The tool assembly of claim 1, wherein the tool assembly further comprises a power component adapted to power at least one of the gearset assembly or the cam assembly.

9. The tool assembly of claim 1, wherein the tool assembly further comprises at least one pusher arm assembly.

10. The tool assembly of claim 1, wherein the cam assembly is made of a rigid material.

11. The tool assembly of claim 2, wherein the expansion ring comprises an elastomeric material.

12. A tool assembly comprising:
a housing;
a gearset assembly; and
at least one movable cam assembly comprising at least one cam operatively connected to the gearset assembly, wherein the cam assembly is adapted to expand, contract, and eject a seal ring onto a component through actuation of the gearset assembly.

13. The tool assembly of claim 12, wherein the gearset assembly comprises a plurality of gears.

14. The tool assembly of claim 12, wherein the housing further comprises a modular head for housing the movable cam assembly.

15. The tool assembly of claim 12, wherein the tool assembly further comprises a fixed handle.

16. The tool assembly of claim 12, wherein the tool assembly further comprises a twist handle.

17. The tool assembly of claim 12, wherein the tool assembly further comprises an eject button.

18. The tool assembly of claim 12, wherein the tool assembly is adapted to expand a seal ring diameter from 3 mm to 3 m.

19. The tool assembly of claim 12, wherein the housing is made of a rigid material.

20. A method comprising:
providing a seal, a fluid component, and tool assembly comprising:
a housing,
a gearset assembly, and
at least one movable cam assembly operatively connected to the gearset assembly, where the cam assembly is adapted to expand, contract, and eject a seal ring onto a component;
positioning the seal onto the cam assembly of the tool assembly;
expanding the seal to a desired size by actuating the cam assembly of the tool assembly; and
ejecting the seal from the cam assembly of the tool assembly onto the fluid component.
